(19) United States
(12) Patent Application Publication
(10) Pub. No.: US 2010/0114532 A1
(43) Pub. Date: May 6, 2010

(54) WEIGHTED SPECTROGRAPHIC MONITORING OF A SUBSTRATE DURING PROCESSING

(75) Inventors: Jeffrey Drue David, San Jose, CA (US); Harry Q. Lee, Los Altos, CA (US); Boguslaw A. Swedek, Cupertino, CA (US); Dominic J. Benvegnu, La Honda, CA (US)

Correspondence Address: FISH & RICHARDSON P.C., P.O. BOX 1022, MINNEAPOLIS, MN, 55440-1022, US

(73) Assignee: Applied Materials, Inc.

(21) Appl. No.: 12/264,094

(22) Filed: Nov. 3, 2008

(51) Int. Cl. G01N 21/25

(52) U.S. Cl. 702/189; 356/300

(57) ABSTRACT

A substrate having an outermost layer undergoing polishing and at least one underlying layer is irradiated with light. A sequence of current spectra is obtained with an in-situ optical monitoring system, a current spectrum from the sequence of current spectra being a spectrum of the light reflected from the substrate, wherein the current spectrum includes a range of wavelengths and, for all wavelengths in the range of wavelengths, a value corresponding to a wavelength. Further, a value of the current spectrum corresponding to a wavelength is modified with at least one value in a gain factor spectrum, wherein the gain factor spectrum includes a first range of wavelengths and, for all wavelengths in the first range of wavelengths, a value corresponding to a wavelength. The polishing of the outermost layer of the substrate is then changed based upon the modified value of the current spectrum.

### BACKGROUND

This disclosure relates generally to spectrographic monitoring of a substrate during chemical mechanical polishing.

An integrated circuit is typically formed on a substrate by the sequential deposition of conductive, semiconductive, or insulative layers on a silicon wafer. One fabrication step involves depositing a filler layer over a non-planar surface and planarizing the filler layer. For certain applications, the filler layer is planarized until the top surface of a patterned layer is exposed. A conductive filler layer, for example, can be deposited on a patterned insulative layer to fill the trenches or holes in the insulative layer. After planarization, the portions of the conductive layer remaining between the raised pattern of the insulative layer form vias, plugs, and lines that provide conductive paths between thin film circuits on the substrate. For other applications, such as oxide polishing, the filler layer is planarized until a predetermined thickness is left over the non planar surface. In addition, planarization of the substrate surface is usually required for photolithography.

Chemical mechanical polishing (CMP) is one accepted method of planarization. This planarization method typically requires that the substrate be mounted on a carrier or polishing head. The exposed surface of the substrate is typically placed against a rotating polishing disk pad or belt pad. The polishing pad can be either a standard pad or a fixed abrasive pad. A standard pad has a durable roughened surface, whereas a fixed-abrasive pad has abrasive particles held in a containment media. The carrier head provides a controllable load on the substrate to push it against the polishing pad. A polishing liquid, such as a slurry with abrasive particles, is typically supplied to the surface of the polishing pad.

One problem in CMP is determining whether the polishing process is complete, i.e., whether a substrate layer has been planarized to a desired flatness or thickness, or when a desired amount of material has been removed. Overpolishing (removing too much) of a conductive layer or film leads to increased circuit resistance. On the other hand, underpolishing (removing too little) of a conductive layer leads to electrical shorting. Variations in the initial thickness of the substrate layer, the slurry composition, the polishing pad condition, the relative speed between the polishing pad and the substrate, and the load on the substrate can cause variations in the material removal rate. These variations cause variations in the time needed to reach the polishing endpoint. Therefore, the polishing endpoint cannot be reliably determined merely as a function of polishing time.

### SUMMARY

A substrate having an outermost layer undergoing polishing and at least one underlying layer is irradiated with light. A sequence of current spectra is obtained with an in-situ optical monitoring system, a current spectrum from the sequence of current spectra being a spectrum of the light reflected from the substrate, wherein the current spectrum includes a range of wavelengths and, for all wavelengths in the range of wavelengths, a value corresponding to a wavelength. Further, a value of the current spectrum corresponding to a wavelength is modified with at least one value in a gain factor spectrum, wherein the gain factor spectrum includes a first range of wavelengths and, for all wavelengths in the first range of wavelengths, a value corresponding to a wavelength. The polishing of the outermost layer of the substrate is then changed based upon the modified value of the current spectrum.

Each modified current spectrum can be compared to a plurality of reference spectra from a first reference spectra library and a first best-match reference spectrum can be determined to generate a first sequence of first best-match reference spectra, each modified current spectrum compared to a plurality of reference spectra from a second reference spectra library and a second best-match reference spectrum determined to generate a second sequence of second best-match reference spectra, determining a first goodness of fit for the first sequence, determining a second goodness of fit for the second sequence, and determining a polishing endpoint based on the first sequence, the second sequence, the first goodness of fit and the second goodness of fit.

Implementation can include one or more of the following.

Comparing a modified current spectrum to a reference spectrum can comprise forming a difference between the modified current spectrum and the reference spectrum. Further, for all reference spectra in the plurality of the reference spectra, the gain factor spectrum can modify the reference spectrum to form a modified reference spectrum before the comparison of the current spectrum and the reference spectrum, the difference between the modified current spectrum and the modified reference spectrum being the same as modifying a difference between the current spectrum and the reference spectrum.

Modifying a current spectrum by, for all wavelengths in the wavelength range, can take the form of multiplying a value of the current spectrum at a wavelength in the wavelength range by a value of the gain factor spectrum corresponding to the wavelength.

The range of wavelengths corresponding to the current spectrum and the first range of wavelengths corresponding to the gain factor spectrum can be identical.

The values of the modified current spectrum and the values of current spectrum that correspond to the same wavelengths can have the same sign.

Values of the gain factor spectrum can be zero over a second range of wavelengths within the first range of wavelengths. In this case, the modified current spectrum can include the second range of wavelengths within the first range of wavelengths such that the values of the modified current spectrum corresponding to the wavelengths in the second range of wavelengths are zero. Determining a first best-match reference spectrum can then include determining which reference spectra from the first reference spectra library has least difference from the modified current spectrum outside of the second range of wavelengths. Further, determining a second best-match reference spectrum can include determining which reference spectra from the second reference spectra library has least difference from the modified current spectrum outside of the second range of wavelength. Still further, a difference between the modified current spectrum and a reference spectrum can be determined either from a sum of differences in the values of the modified current spectrum and the reference spectrum over a range of wavelengths, or from a mean square error between the values of the modified current spectrum and the reference spectrum over a range of wavelengths.

The gain factor spectrum can be stored as a set of values for discrete wavelengths on a machine-readable storage medium. The stored set of values for discrete wavelengths can have values for intermediate wavelengths determined either by linear interpolation from the values at the adjacent discrete wavelengths or by Bezier functions. The values of the gain factor spectrum can be set using a graphical user interface.

In an aspect, a computer-implemented method comprises steps as outlined above.

In another aspect, a computer program product, tangibly embodied in a computer readable medium, is operable to cause a data processing apparatus to perform operations comprising the steps of the method above.

In yet another aspect, an apparatus can be configured to perform the steps outlined above.

In a further embodiment, a computer implemented method comprises irradiating a substrate undergoing polishing with light to generate reflected light. The method further comprises obtaining a current spectrum of the reflected light with an in-situ optical monitoring system. The method still further comprises computing a value representing a modification of a difference spectrum representing a difference between the current spectrum and a reference spectrum with a gain spectrum and determining a polishing endpoint using the gain-adjusted difference spectrum.

In a still further embodiment, a computer implemented method comprises irradiating a substrate undergoing polishing with light to generate reflected light. The method further comprises obtaining a current spectrum of the reflected light with an in-situ optical monitoring system. The method still further comprises determining a best match spectrum to the current spectrum from a plurality of reference spectra, the determining including weighting with a gain function with different values for different wavelengths and determining a polishing endpoint using the best match spectrum.

As used in the instant specification, the term substrate can include, for example, a product substrate (e.g., which can include multiple memory or processor dies), a test substrate, a bare substrate, and a gating substrate. The substrate can be at various stages of integrated circuit fabrication, e.g., the substrate can be a bare wafer, or it can include one or more deposited and/or patterned layers. The term substrate can include circular disks and rectangular sheets.

Possible advantages of implementations can include the following. Reliability of matching of measured spectra to reference spectra can be improved, thus improving reliability of endpoint detection. The endpoint detection system can be less sensitive to variations between substrates in the underlying layers or pattern, and less sensitive to signal noise. As a result, wafer-to-wafer uniformity can be improved.

The details of one or more embodiments are set forth in the accompanying drawings and the description below. Other features, objects, and advantages will be apparent from the description and drawings, and from the claims.

### DESCRIPTION OF DRAWINGS

FIG. 1 shows a cross-section of a portion of a substrate.

FIG. 2 shows a chemical mechanical polishing apparatus.

FIG. 3 is an overhead view of a rotating platen illustrating locations of in situ measurements.

FIG. 4 illustrates an index trace from a spectrographic monitoring system showing a good data fit.

FIG. 5 illustrates an index trace from a spectrographic monitoring system showing a poorer fit.

FIG. 6 is a plot of a measured spectrum, a gain factor array, and a resulting effective spectrum against wavelength.

FIG. 7 is a flow diagram of an implementation of determining a polishing endpoint.

Like reference symbols in the various drawings indicate like elements.

### DETAILED DESCRIPTION

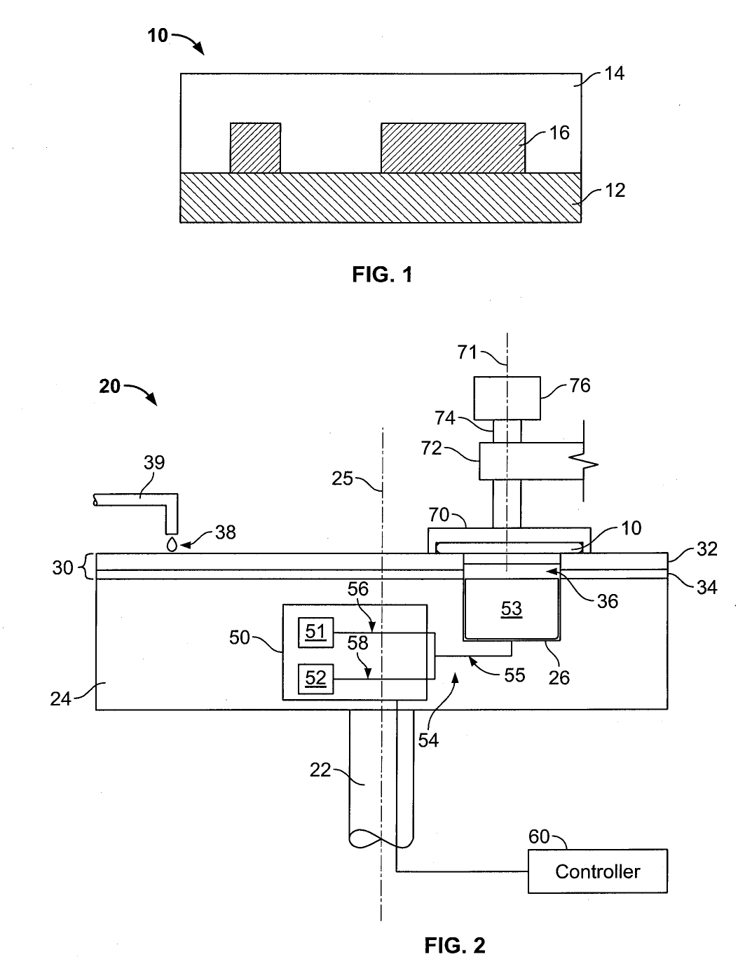

Referring to FIG. 1, a substrate 10 can include a wafer 12, an outermost layer 14 that will undergo polishing, and one or more underlying layers 16, some of which are typically patterned, between the outermost layer 16 and the wafer 12. For example, the outermost layer 14 and an immediately adjacent underlying layer can both be dielectrics, e.g., the outermost layer 16 can be an oxide and the immediately adjacent underlying layer can be a nitride. Other layers, such as other conductive and dielectric layers, can be formed between the immediately adjacent underlying layer and the substrate.

One potential problem with spectrographic endpoint detection during chemical mechanical polishing, particularly spectrographic endpoint detection where both the outermost layer 14 and the underlying layer 16 are dielectrics, is that the thickness(es) of the underlying layer(s) can vary from substrate to substrate. As a result, substrates in which the outermost layer has the same thickness can actually reflect different spectra, depending on the underlying layer(s). Consequently, a target spectrum used to trigger a polishing endpoint for some substrates may not function properly for other substrates, e.g., if the underlying layers have different thicknesses. However, it is possible to compensate for this effect by comparing spectra obtained during polishing against multiple spectra, where the multiple spectra represent variations in the underlying layer(s). Variations in underlying substrate may be caused by variability in the process used to build those underlying substrates.

Variations can also inherently exist between reference spectra that are determined using one substrate versus another due to variations between substrates other than underlying layer thickness, such as starting thickness of the outermost layer undergoing polishing, variations in the optical properties of the environment, variations in the pattern of the underlying layer, e.g., line width (e.g., metal or polysilicon line width), or variations in composition of the layers. However, it is similarly possible to compensate for this effect by comparing spectra obtained during polishing against multiple spectra, where the multiple spectra represent other variations between the substrates.

In addition, it is possible to compensate for variations using multiple libraries of reference spectra. Within each library are multiple reference spectra representing substrates with variations in the thickness of the outermost layer but with otherwise similar characteristics, e.g., similar underlying layer thickness. Between libraries, other variations, such as variations in thickness of underlying layer(s), can be represented, e.g., different libraries include reference spectra representing substrates with different thickness of underlying layer(s).

FIG. 2 shows a polishing apparatus 20 operable to polish a substrate 10. The polishing apparatus 20 includes a rotatable disk-shaped platen 24, on which a polishing pad 30 is situated. The platen is operable to rotate about an axis 25. For example, a motor can turn a drive shaft 22 to rotate the platen 24.

An optical access 36 through the polishing pad is provided by including an aperture (i.e., a hole that runs through the pad) or a solid window. The solid window can be secured to the polishing pad, although in some implementations the solid window can be supported on the platen 24 and project into an aperture in the polishing pad. The polishing pad 30 is usually placed on the platen 24 so that the aperture or window overlies an optical head 53 situated in a recess 26 of the platen 24. The optical head 53 consequently has optical access through the aperture or window to a substrate being polished. The optical head is further described below.

The polishing apparatus 20 includes a combined slurry/rinse arm 39. During polishing, the arm 39 is operable to dispense a polishing liquid 38, such as a slurry. Alternatively, the polishing apparatus includes a slurry port operable to dispense slurry onto the polishing pad 30.

The polishing apparatus 20 includes a carrier head 70 operable to hold the substrate 10 against the polishing pad 30. The carrier head 70 is suspended from a support structure 72, for example, a carousel, and is connected by a carrier drive shaft 74 to a carrier head rotation motor 76 so that the carrier head can rotate about an axis 71. In addition, the carrier head 70 can oscillate laterally in a radial slot formed in the support structure 72. In operation, the platen is rotated about its central axis 25, and the carrier head is rotated about its central axis 71 and translated laterally across the top surface of the polishing pad.

The polishing apparatus also includes an optical monitoring system, which can be used to determine a polishing endpoint as discussed below. The optical monitoring system includes a light source 51 and a light detector 52. Light passes from the light source 51, through the optical access 36 in the polishing pad 30, impinges and is reflected from the substrate 10 back through the optical access 36, and travels to the light detector 52.

A bifurcated optical cable 54 can be used to transmit the light from the light source 51 to the optical access 36 and back from the optical access 36 to the light detector 52. The bifurcated optical cable 54 can include a “trunk” 55 and two “branches” 56 and 58.

As mentioned above, the platen 24 includes the recess 26, in which the optical head 53 is situated. The optical head 53 holds one end of the trunk 55 of the bifurcated fiber cable 54, which is configured to convey light to and from a substrate surface being polished. The optical head 53 can include one or more lenses or a window overlying the end of the bifurcated fiber cable 54. Alternatively, the optical head 53 can merely hold the end of the trunk 55 adjacent the solid window in the polishing pad.

The platen includes a removable in-situ monitoring module 50. The in-situ monitoring module 50 can include one or more of the following: the light source 51, the light detector 52, and circuitry for sending and receiving signals to and from the light source 51 and light detector 52. For example, the output of the detector 52 can be a digital electronic signal that passes through a rotary coupler, e.g., a slip ring, in the drive shaft 22 to a controller 60, such as a computer, for the optical monitoring system. Similarly, the light source can be turned on or off in response to control commands in digital electronic signals that pass from the controller through the rotary coupler to the module 50.

The in-situ monitoring module can also hold the respective ends of the branch portions 56 and 58 of the bifurcated optical fiber 54. The light source is operable to transmit light, which is conveyed through the branch 56 and out the end of the trunk 55 located in the optical head 53, and which impinges on a substrate being polished. Light reflected from the substrate is received at the end of the trunk 55 located in the optical head 53 and conveyed through the branch 58 to the light detector 52.

The light source 51 is operable to emit white light. In one implementation, the white light emitted includes light having wavelengths of 200- 800 nanometers. A suitable light source is a xenon lamp or a xenon mercury lamp.

The light detector 52 can be a spectrometer. A spectrometer is basically an optical instrument for measuring intensity of light over a portion of the electromagnetic spectrum. A suitable spectrometer is a grating spectrometer. Typical output for a spectrometer is the intensity of the light as a function of wavelength (or frequency).

The light source 51 and light detector 52 are connected to a computing device, e.g., the controller 60, operable to control their operation and to receive their signals. The computing device can include a microprocessor situated near the polishing apparatus, e.g., a personal computer. With respect to control, the computing device can, for example, synchronize activation of the light source 51 with the rotation of the platen 24.

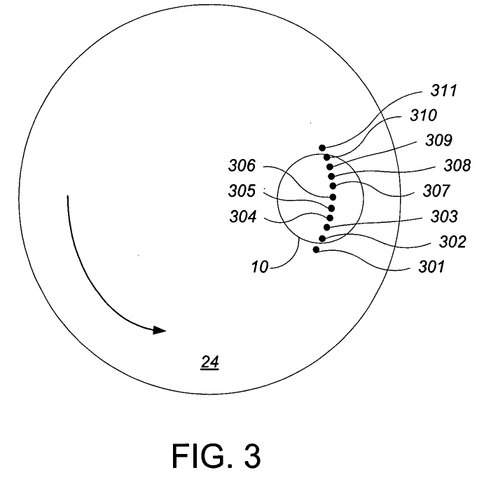

As shown in FIG. 3, as the platen rotates, the computer can cause the light source 51 to emit a series of flashes starting just before and ending just after the substrate 10 passes over the in-situ monitoring module (each of points 301-311 depicted represents a location where light from the in-situ monitoring module impinged and reflected off.) Alternatively, the computer can cause the light source 51 to emit light continuously starting just before and ending just after the substrate 10 passes over the in-situ monitoring module. In either case, the signal from the detector can be integrated over a sampling period to generate spectra measurements at a sampling frequency. The sampling frequency can be about 10 Hz to about 300 Hz.

Although not shown, each time the substrate 10 passes over the monitoring module, the alignment of the substrate with the monitoring module can be different than in the previous pass. Over one rotation of the platen, spectra are obtained from different radii on the substrate. That is, some spectra are obtained from locations closer to the center of the substrate and some are closer to the edge. In addition, over multiple rotations of the platen, a sequence of spectra can be obtained over time.

In operation, the computing device can receive, for example, a signal that carries information describing a spectrum of the light received by the light detector 52 for a particular flash of the light source or time frame of the detector. Thus, this spectrum is a spectrum measured in-situ during polishing.

Without being limited to any particular theory, the spectrum of light reflected from the substrate 10 evolves as polishing progresses due to changes in the thickness of the outermost layer, thus yielding a sequence of time-varying spectra. Moreover, particular spectra are exhibited by particular thicknesses of the layer stack.

The computing device can process the signal to determine an endpoint of a polishing step. In particular, the computing device can execute logic that determines, based on the measured spectra, when an endpoint has been reached.

In brief, the computing device can compare the measured spectra to multiple reference spectra, and can use the results of the comparison to determine when an endpoint has been reached.

As used herein, a reference spectrum is a predefined spectrum generated prior to polishing of the substrate. A reference spectrum can have a pre-defined association, i.e., defined prior to the polishing operation, with a value of a substrate property, such as a thickness of the outermost layer. Alternatively or in addition, the reference spectrum can have a pre-defined association with value representing a time in the polishing process at which the spectrum is expected to appear, assuming that the actual polishing rate follows an expected polishing rate.

A reference spectrum can be generated empirically, e.g., by measuring the spectrum from a test substrate having a known layer thicknesses, or generated from theory. For example, to determine a reference spectrum, a spectrum of a “set-up” substrate with the same pattern as the product substrate can be measured pre-polish at a metrology station. A substrate property, e.g., the thickness of the outermost layer, can also be measured pre-polish with the same metrology station or a different metrology station. The set-up substrate is then polished while spectra are collected. For each spectrum, a value is recorded representing the time in the polishing process at which the spectrum was collected. For example, the value can be an elapsed time, or a number of platen rotations. The substrate can be overpolished, i.e., polished past a desired thickness, so that the spectrum of the light that reflected from the substrate when the target thickness is achieved can be obtained. The spectrum and property, e.g., thickness of the outermost layer, of the set-up substrate can then be measured post-polish at a metrology station.

Optionally, the set-up substrate can be removed periodically from the polishing system, and its properties and/or spectrum measured at a metrology station, before being returned to polishing. A value can also be recorded representing the time in the polishing process at which the spectrum is measured at the metrology station.

The reference spectra are stored in a library. The reference spectra in the library represent substrates with a variety of different thicknesses in the outer layer.

Multiple libraries can be created from different set-up substrates that differ in characteristics other than the thickness of the outermost layer, e.g., that differ in underlying layer thickness, underlying layer pattern, or outer or underlying layer composition.

The measured thicknesses and the collected spectra are used to select, from among the collected spectra, one or more spectra determined to be exhibited by the substrate when it had a thickness of interest. In particular, linear interpolation can be performed using the measured pre polish film thickness and post polish substrate thicknesses (or other thicknesses measured at the metrology station) to determine the time and corresponding spectrum exhibited when the target thickness was achieved. The spectrum or spectra determined to be exhibited when the target thickness was achieved are designated to be the target spectrum or target spectra.

In addition, assuming a uniform polishing rate a thickness of the outermost layer can be calculated for each spectrum collected in-situ using linear interpolation between the measured pre polish film thickness and post polish substrate thicknesses (or other thicknesses measured at the metrology station) based on the time at which the spectrum was collected and time entries of the measured spectra.

In addition to being determined empirically, some or all of the reference spectra can be calculated from theory, e.g., using an optical model of the substrate layers. For example, an optical model can be used to calculate a spectrum for a given outer layer thickness D. A value representing the time in the polishing process at which the spectrum would be collected can be calculated, e.g., by assuming that the outer layer is removed at a uniform polishing rate. For example, the time Ts for a particular spectrum can be calculated simply by assuming a starting thickness DO and uniform polishing rate R (Ts=(D0−D)/R). As another example, linear interpolation between measurement times T1, T2 for the pre-polish and post-polish thicknesses D1, D2 (or other thicknesses measured at the metrology station) based on the thickness D used for the optical model can be performed (Ts=T2−T1*(D1−D)/(D1−D2)).

As used herein, a library of reference spectra is a collection of reference spectra which represent substrates that share a property in common (other than outer layer thickness). However, the property shared in common in a single library may vary across multiple libraries of reference spectra. For example, two different libraries can include reference spectra that represent substrates with two different underlying thicknesses.

Spectra for different libraries can be generated by polishing multiple “set-up” substrates with different substrate properties (e.g., underlying layer thicknesses, or layer composition) and collecting spectra as discussed above; the spectra from one set-up substrate can provide a first library and the spectra from another substrate with a different underlying layer thickness can provide a second library. Alternatively or in addition, reference spectra for different libraries can be calculated from theory, e.g., spectra for a first library can be calculated using the optical model with the underlying layer having a first thickness, and spectra for a second library can be calculated using the optical model with the underlying layer having a different thickness.

In some implementations, each reference spectrum is assigned an index value. This index can be the value representing the time in the polishing process at which the reference spectrum is expected to be observed. The spectra can be indexed so that each spectrum in a particular library has a unique index value. The indexing can be implemented so that the index values are sequenced in an order in which the spectra were measured. An index value can be selected to change monotonically, e.g., increase or decrease, as polishing progresses. In particular, the index values of the reference spectra can be selected so that they form a linear function of time or number of platen rotations. For example, the index values can be proportional to a number of platen rotations. Thus, each index number can be a whole number, and the index number can represent the expected platen rotation at which the associated spectrum would appear.

The reference spectra and their associated indices can be stored in a library. The library can be implemented in memory of the computing device of the polishing apparatus. The index of the target spectrum can be designated as a target index.

During polishing, an index trace can be generated for each library. Each index trace includes a sequence of indices that form the trace, each particular index of the sequence associated with a particular measured spectrum. For the index trace of a given library, a particular index in the sequence is generated by selecting the index of the reference spectrum from the given library that is the closest fit to a particular measured spectrum.

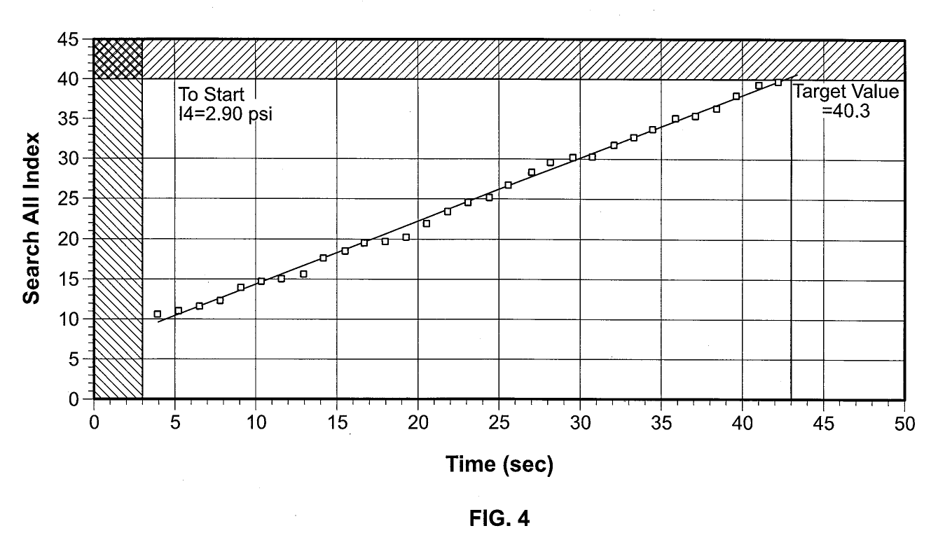

As shown in FIG. 4, the indexes 80 corresponding to each measured spectrum can be plotted according to time or platen rotation. A polynomial function of known order, e.g., a first-order function (i.e., a line) is fit to the plotted index numbers, e.g., using robust line fitting. Where the line meets the target index defines the endpoint time or rotation. For example, a first-order function 82 is fit to the data points as shown in FIG. 44.

Without being limited to any particular theory, some libraries can predict proper endpoints than others because they match the measured data more consistently. For example, out of multiple libraries representing substrates with different underlying layer thickness, the library which is the closest match to the underlying layer thickness of the measured substrate should provide the best match. Thus a benefit is a more accurate endpoint detection system achieved by utilizing multiple reference spectra libraries.

In some applications, it can be advantageous to assign a gain factor spectrum value to each wavelength in a measured spectrum. The gain factor spectrum value modifies each value in the difference spectrum (i.e., the difference between the measured spectrum and the reference spectrum) in order to obtain an effective difference spectrum over the wavelength range of the measured spectrum. In effect, the gain factor spectrum acts as a weighting function so that different regions of the spectrum can be weighted differently in determining the degree of difference between the reference spectrum and the measured spectrum and determining whether the reference spectrum is a match to the measured spectrum. The modification can be a multiplication of a value of the difference between the measured spectrum and the reference spectrum at a wavelength by the value of the gain factor spectrum at that wavelength. The wavelength range corresponding to the gain factor spectrum can be identical to that corresponding to the measured spectrum. The gain factor spectrum can depend upon the particular reference library to which the measured spectrum is being compared.

A gain factor spectrum can be used in response to known noisy or problematic regions of the wavelength spectrum. Such noise or problematic regions can be a result of, e.g., a faulty detector or patterning on a device wafer. For example, the gain factor spectrum can take on values between zero and one, and a fractional representation may represent an expected signal-to-noise ratio of a signal representing the current spectrum. Using a gain factor spectrum makes the system less sensitive to parts of the spectra that provide no value to the endpoint determination, and can amplify the signal in areas that add a lot of value to endpoint determination.

A gain factor spectrum can also be used to separate a single spectrum over a wavelength range into two separate spectra with wavelength ranges separated by a gap. For example, a range of 360 nm - 800 nm can be split into a 360 nm - 450 nm range and a 550 nm - 800 nm range, with a gap between 450 nm and 550 nm. The gain factor spectrum would have zeros in a range corresponding to the gap.

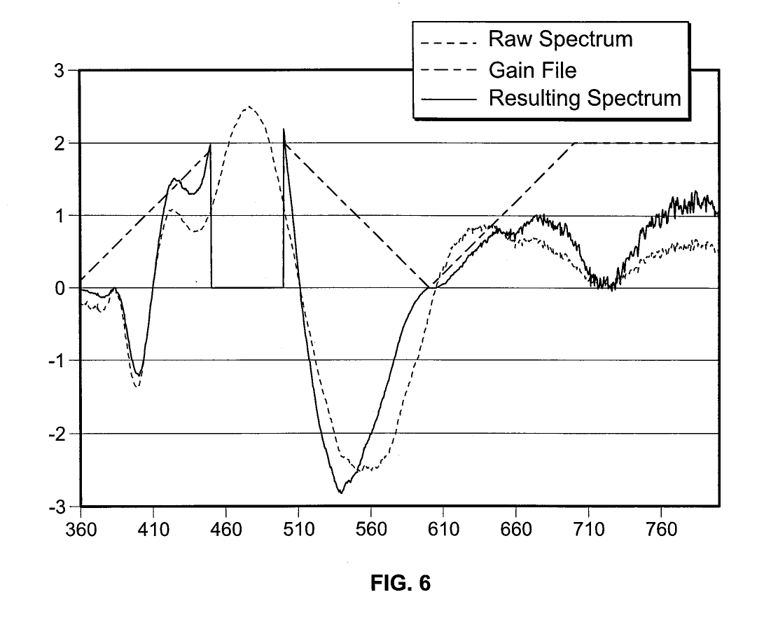

A gain factor spectrum is illustrated in the plot in FIG. 6. There, the modification of the difference spectrum by the gain factor spectrum is one of multiplication of values with the same wavelength. Note that the gain factor spectrum here does not change the sign of the measured spectrum because all values of the gain factor spectrum are non-negative; this is usually the case in many applications, but is not a necessity. The gain factor spectrum can also be considered to provide a gain value as a function of wavelength.

The function defining the gain factor spectrum can be stored as a set of values for discrete wavelengths, with values for intermediate wavelengths determined by linear interpolation from the values at the adjacent discrete wavelengths. Alternatively, more complicated functions, e.g., Bezier functions, can be used to define the gain factor spectrum. Alternatively, the gain factor spectrum values can be represented as an array of values over the wavelength range of the measured spectrum, the array having a size equal to that of the measured spectrum.

Note that, in FIG. 6, some of the values of the current spectrum are less than zero because the mean of the entire processed spectra was subtracted out, thus normalizing around zero. This is not necessary, and the gain factor spectrum may modify the raw spectrum directly. If such a subtraction is taken, however, the same subtraction is made to the reference spectra.

The values of the gain factor spectrum can be set by a user through a graphical user interface. For example, where the gain factor spectrum is stored as a set of values for discrete wavelengths, a graphical user interface could display the gain factor spectrum, and permit a user to add a draggable vertex point by clicking on a desired point on the function, then drag the vertex in order to set the gain value at the wavelength of the vertex. This permits the user to develop and quickly modify the gain factor spectrum. The gain factor spectrum can also be set by the user via a text file. For every intensity value at each wavelength increment, there is a corresponding gain value. These gain values can be stored in an array in a text file.

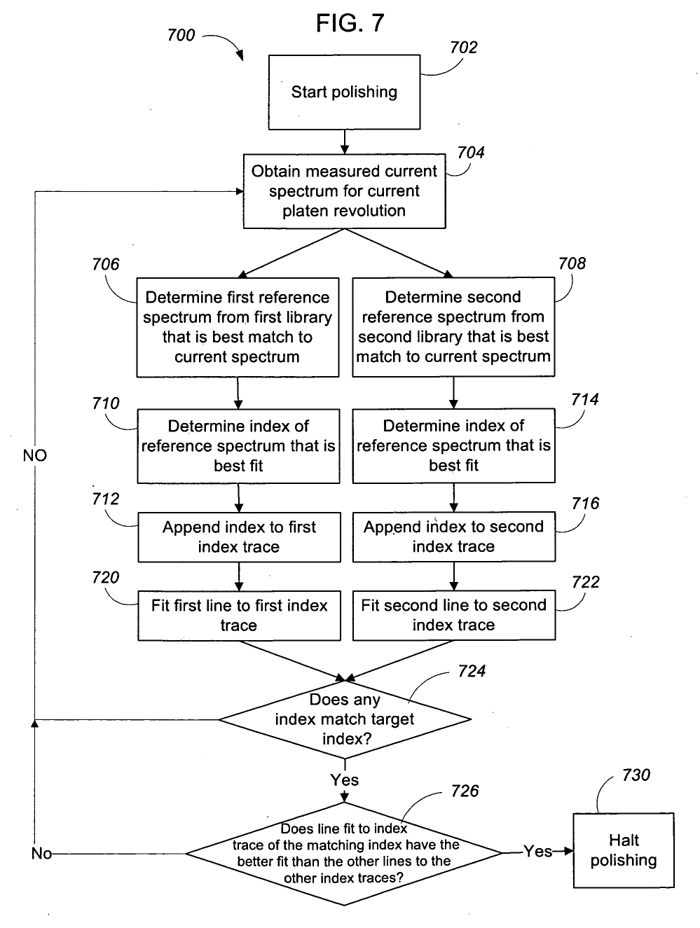

FIG. 7 shows a method 700 for determining an endpoint of a polishing step. A substrate from the batch of substrates is polished (step 702), and the following steps are performed for each platen revolution. One or more spectra are measured to obtain a current spectrum for a current platen revolution (step 704). A first best-match reference spectrum stored in a first spectra library which best fits the current spectrum is determined (step 706). A second best-match reference spectrum stored in a second spectra library which best fits the current spectra is determined (step 708). More generally, for each library, the reference spectrum that is the best-match to the current spectrum is determined. The index of the first best-matched reference spectrum from the first library that is the best fit to the current spectrum is determined (step 710), and is appended to a first index trace (step 712) associated with the first library. The index of the second best-match reference spectra from the second library that is the best fit to the current spectrum is determined (step 714), and is appended to a second index trace (step 716) associated with the second library. More generally, for each library, the index for each best-match reference spectrum is determined and appended to an index trace for the associated library. A first line is fit to the first index trace (step 720), and a second line is fit to the second index trace (step 722). More generally, for each index trace, a line can be fit to the index trace. The lines can be fit using robust line fitting.

Endpoint is called (step 730) when the index of the first best-match spectra matches or exceeds the target index (step 724) and the index trace associated with the first spectra library has the best goodness of fit to the robust line associated with the first spectra library (step 726), or when the index of the second best-match spectra matches or exceeds the target index (step 724) and the index trace associated with the second spectra library has the best goodness of fit to the robust line associated with the second spectra library (step 726). More generally, endpoint can be called when the index trace with the best fit to its associated fitted line matches or exceeds the target index.

Also, rather than comparing the index values themselves to the target index, the value of the fitted line at the current time can be compared to the target index. That is, a value (which need not be an integer in this context) is calculated for the current time from the linear function, and this value is compared to the target index.

Determining whether an index trace associated with a spectra library has the best goodness of fit to the linear function associated with the library can include determining whether the index trace of the associated spectra library has the least amount of difference from the associated robust line, relatively, as compared to the differences from the associated robust line and index trace associated with another library, e.g., the lowest standard deviation, the greatest correlation, or other measure of variance. In one implementation, the goodness of fit is determined by calculating a sum of squared differences between the index data points and the linear function; the library with the lowest sum of squared differences has the best fit.

If one of the index traces reaches the target index but is not the best fit, then the system can wait until the either that index trace is the best fit, or the index trace that is the best fit reaches the target index.

Although only two libraries and two index traces are discussed above, the concept is applicable to more than two libraries that would provide more than two index traces. In addition, rather than calling endpoint when the index of the trace matches a target index, endpoint could be called at the time calculated for the line fit to the trace to cross the target index. Moreover, it would be possible to reject the index traces with worst fit before the endpoint, e.g., about 40% to 50% through the expected polishing time, in order to reduce processing.

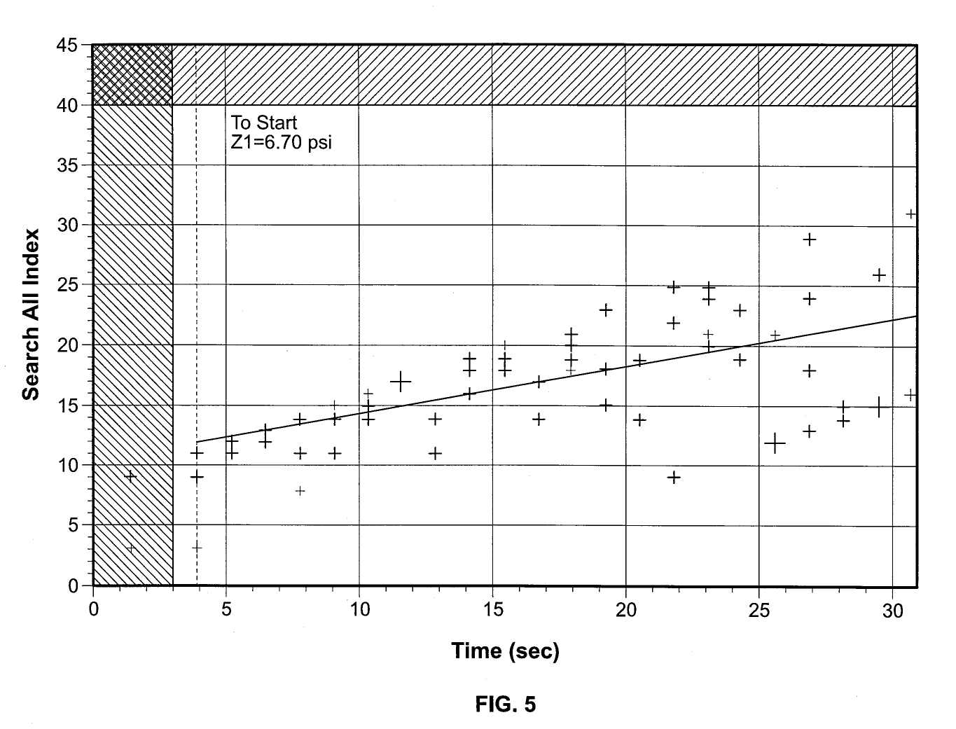

By way of an example, FIG. 4 shows index data with a good fit to the calculated linear function, while FIG. 5 shows index data with a poorer fit to the calculated linear function.

Obtaining a current spectrum can include measuring at least one spectrum of light reflecting off a substrate surface being polished (step 704). Optionally, multiple spectra can be measured, e.g., spectra measured at different radii on the substrate can be obtained from a single rotation of platen, e.g., at points 301-311 (FIG. 3). If multiple spectra are measured, a subset of one or more of the spectra can be selected for use in the endpoint detection algorithm. For example, spectra measured at sample locations near the center of the substrate (for example, at points 305, 306, and 307 shown in FIG. 3) could be selected. The spectra measured during the current platen revolution are optionally processed to enhance accuracy and/or precision.

Determining a difference between each of the selected measured spectra and each of the reference spectra (step 706 or 710) can include calculating the difference Δ as a sum of differences in intensities over a range of wavelengths. That is,

$$Δ = {\sum }_{λ = a}^{b} \vert G ( λ ) [ {I}_{current} ( λ ) - {I}_{reference} ( λ ) ] \vert$$

where a and b are the lower limit and upper limit of the range of wavelengths of a spectrum, respectively, G(λ) is the value of the gain factor spectrum at the wavelength λ, and I_{current}(λ) and I_{reference}(λ) are the intensity of a current spectra and the intensity of the reference spectra for a given wavelength, respectively. Note that the reference spectrum is also modified using the gain factor spectrum.

Alternatively, the difference A can be calculated as a mean square error, that is:

$$Δ = {\sum }_{λ = a}^{b} {\vert G ( λ ) [ {I}_{current} ( λ ) - {I}_{reference} ( λ ) ] \vert}^{2}$$

Note that, if the gain factor spectrum has a gap, the sum may be split into sums over the intervals over which the gain factor spectrum values are nonzero.

Where there are multiple current spectra, a best match can be determined between each of the current spectra and each of the reference spectra of a given library. Each selected current spectra is compared against each reference spectra. Given current spectra e, f, and g, and reference spectra E, F, and G, for example, a matching coefficient could be calculated for each of the following combinations of current and reference spectra: e and E, e and F, e and G, f and E, f and F, f and G, g and E, g and F, and g and G. Whichever matching coefficient indicates the best match, e.g., is the smallest, determines the reference spectrum, and thus the index.

Determining whether an index trace associated with a spectra library has the best goodness of fit to the robust line associated with the spectra library (step 720 or 724) may include determining which library has the least sum of squared differences between the data points comprising an index trace and the robust line fitted to the associated with the spectra library. For example, the least sum of squared differences between the data points as represented in FIG. 4 and FIG. 5 and their respective associated robust lines.

A method that can be applied during the endpoint process is to limit the portion of the library that is searched for matching spectra. The library typically includes a wider range of spectra than will be obtained while polishing a substrate. The wider range accounts for spectra obtained from a thicker starting outermost layer and spectra obtained after overpolishing. During substrate polishing, the library searching is limited to a predetermined range of library spectra. In some embodiments, the current rotational index N of a substrate being polished is determined. N can be determined by searching all of the library spectra. For the spectra obtained during a subsequent rotation, the library is searched within a range of freedom of N. That is, if during one rotation the index number is found to be N, during a subsequent rotation which is X rotations later, where the freedom is Y, the range that will be searched from (N+X)−Y to (N+X)+Y. For example, if at the first polishing rotation of a substrate, the matching index is found to be 8 and the freedom is selected to be 5, for spectra obtained during the second rotation, only spectra corresponding to index numbers 9±5 are examined for a match. When this method is applied, the same method can be independently applied to all of the libraries currently being used in the endpoint detection process.

Embodiments and all of the functional operations described in this specification can be implemented in digital electronic circuitry, or in computer software, firmware, or hardware, including the structural means disclosed in this specification and structural equivalents thereof, or in combinations of them. Embodiments can be implemented as one or more computer program products, i.e., one or more computer programs tangibly embodied in a machine readable storage media, for execution by, or to control the operation of, data processing apparatus, e.g., a programmable processor, a computer, or multiple processors or computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, subprograms, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

The above described polishing apparatus and methods can be applied in a variety of polishing systems. Either the polishing pad, or the carrier head, or both can move to provide relative motion between the polishing surface and the substrate. For example, the platen may orbit rather than rotate. The polishing pad can be a circular (or some other shape) pad secured to the platen. Some aspects of the endpoint detection system may be applicable to linear polishing systems, e.g., where the polishing pad is a continuous or a reel-to-reel belt that moves linearly. The polishing layer can be a standard (for example, polyurethane with or without fillers) polishing material, a soft material, or a fixed-abrasive material. Terms of relative positioning are used; it should be understood that the polishing surface and substrate can be held in a vertical orientation or some other orientation.

Particular embodiments have been described. Other embodiments are within the scope of the following claims. For example, the actions recited in the claims can be performed in a different order and still achieve desirable results.

What is claimed is:

1. A computer implemented method comprising:
irradiating a substrate with light, the substrate having an outermost layer undergoing polishing and at least one underlying layer;
obtaining a sequence of current spectra with an in-situ optical monitoring system, each a current spectrum from the sequence of current spectra being a spectrum of the light reflected from the substrate, wherein the current spectrum includes a range of wavelengths and, for all wavelengths in the range of wavelengths, a value corresponding to a wavelength;
computing, with a data processing apparatus, a value representing a function of the current spectrum and a gain factor spectrum, wherein the gain factor spectrum includes a first range of wavelengths and, for all wavelengths in the first range of wavelengths, a value corresponding to a wavelength; and
changing, with a controller, the polishing of the outermost layer of the substrate based on the computed value from the data processing apparatus.

2. The method of claim 1, further comprising:
comparing, with a data processing apparatus, each modified current spectrum to a plurality of reference spectra from a first reference spectra library and determining a first best-match reference spectrum to generate a first sequence of first best-match reference spectra;
comparing, with a data processing apparatus, each modified current spectrum to a plurality of reference spectra from a second reference spectra library and determining a second best-match reference spectrum to generate a second sequence of second best-match reference spectra;
determining, with a data processing apparatus, a first goodness of fit for the first sequence;
determining, with a data processing apparatus, a second goodness of fit for the second sequence; and
determining, with a data processing apparatus, a polishing endpoint based on the first sequence, the second sequence, the first goodness of fit and the second goodness of fit.

3. The method of claim 2, wherein comparing a modified current spectrum to a reference spectrum comprises forming a difference between the modified current spectrum and the reference spectrum.

4. The method of claim 3, wherein, for all reference spectra in the plurality of the reference spectra, the gain factor spectrum modifies the reference spectrum to form a modified reference spectrum before the comparison of the current spectrum and the reference spectrum, the difference between the modified current spectrum and the modified reference spectrum being the same as modifying a difference between the current spectrum and the reference spectrum.

5. The method of claim 2, wherein modifying a current spectrum comprises, for all wavelengths in the wavelength range, multiplying a value of the current spectrum at a wavelength in the wavelength range by a value of the gain factor spectrum corresponding to the wavelength.

6. The method of claim 2, wherein the range of wavelengths corresponding to the current spectrum and the first range of wavelengths corresponding to the gain factor spectrum are identical.

7. The method of claim 2, wherein values of the gain factor spectrum are zero over a second range of wavelengths within the first range of wavelengths.

8. The method of claim 7, wherein the modified current spectrum includes the second range of wavelengths within the first range of wavelengths such that the values of the modified current spectrum corresponding to the wavelengths in the second range of wavelengths are zero.

9. The method of claim 2, wherein the values of the modified current spectrum and the values of current spectrum that correspond to the same wavelengths have the same sign.

10. The method of claim 8, wherein determining a first best-match reference spectrum includes determining which reference spectra from the first reference spectra library has least difference from the modified current spectrum outside of the second range of wavelengths, and wherein determining a second best-match reference spectrum includes determining which reference spectra from the second reference spectra library has least difference from the modified current spectrum outside of the second range of wavelength.

11. The method of claim 10, wherein a difference between the modified current spectrum and a reference spectrum is determined from a sum of differences in the values of the modified current spectrum and the reference spectrum over a range of wavelengths.

12. The method of claim 10, wherein a difference between the modified current spectrum and a reference spectrum is determined from a mean square error between the values of the modified current spectrum and the reference spectrum over a range of wavelengths.

13. A computer program product, tangibly embodied in a machine readable storage medium encoded on a tangible program carrier, operable to cause data processing apparatus to perform operations comprising:
irradiating a substrate with light, the substrate having an outermost layer undergoing polishing and at least one underlying layer;
obtaining a sequence of current spectra with an in-situ optical monitoring system, each a current spectrum from the sequence of current spectra being a spectrum of the light reflected from the substrate, wherein the current spectrum includes a range of wavelengths and, for all wavelengths in the range of wavelengths, a value corresponding to a wavelength;
modifying a value of the current spectrum corresponding to a wavelength with at least one value in a gain factor spectrum, wherein the gain factor spectrum includes a first range of wavelengths and, for all wavelengths in the first range of wavelengths, a value corresponding to a wavelength; and
changing the polishing of the outermost layer of the substrate based upon the modified value of the current spectrum.

14. The computer program product of claim 13, further comprising:
comparing each modified current spectrum to a plurality of reference spectra from a first reference spectra library and determining a first best-match reference spectrum to generate a first sequence of first best-match reference spectra;
comparing each modified current spectrum to a plurality of reference spectra from a second reference spectra library and determining a second best-match reference spectrum to generate a second sequence of second best-match reference spectra;
determining a first goodness of fit for the first sequence;
determining a second goodness of fit for the second sequence; and
determining a polishing endpoint based on the first sequence, the second sequence, the first goodness of fit and the second goodness of fit.

15. The computer program product of claim 14, wherein comparing a modified current spectrum to a reference spectrum comprises forming a difference between the modified current spectrum and the reference spectrum.

16. The computer program product of claim 15, wherein, for all reference spectra in the plurality of the reference spectra, the gain factor spectrum modifies the reference spectrum to form a modified reference spectrum before the comparison of the current spectrum and the reference spectrum, the difference between the modified current spectrum and the modified reference spectrum being the same as modifying a difference between the current spectrum and the reference spectrum.

17. The computer program product of claim 14, wherein modifying a current spectrum comprises, for all wavelengths in the wavelength range, multiplying a value of the current spectrum at a wavelength in the wavelength range by a value of the gain factor spectrum corresponding to the wavelength.

18. The computer program product of claim 14, wherein the range of wavelengths corresponding to the current spectrum and the first range of wavelengths corresponding to the gain factor spectrum are identical.

19. The computer program product of claim 14, wherein values of the gain factor spectrum are zero over a second range of wavelengths within the first range of wavelengths.

20. The computer program product of claim 19, wherein the modified current spectrum includes the second range of wavelengths within the first range of wavelengths such that the values of the modified current spectrum corresponding to the wavelengths in the second range of wavelengths are zero.

21. The computer program product of claim 13, wherein the values of the modified current spectrum and the values of current spectrum that correspond to the same wavelengths have the same sign.

22. The computer program product of claim 21, wherein determining a first best-match reference spectrum includes determining which reference spectra from the first reference spectra library has least difference from the modified current spectrum outside of the second range of wavelengths, and wherein determining a second best-match reference spectrum includes determining which reference spectra from the second reference spectra library has least difference from the modified current spectrum outside of the second range of wavelength.

23. The computer program product of claim 22, wherein a difference between the modified current spectrum and a reference spectrum is determined from a sum of differences in the values of the modified current spectrum and the reference spectrum over a range of wavelengths.

24. The computer program product of claim 22, wherein a difference between the modified current spectrum and a reference spectrum is determined from a mean square error between the values of the modified current spectrum and the reference spectrum over a range of wavelengths.

25. An apparatus, comprising:
a polishing pad configured to polish a substrate having an outermost layer and at least one underlying layer;
a light source configured to irradiate the substrate with light;
an in-situ optical monitoring system configured to obtain a sequence of current spectra, each a current spectrum from the sequence of current spectra being a spectrum of the light reflected from the substrate, wherein the current spectrum includes a range of wavelengths and, for all wavelengths in the range of wavelengths, a value corresponding to a wavelength; and
a data processing apparatus configured to modify a value of the current spectrum corresponding to a wavelength with at least one value in a gain factor spectrum, wherein the gain factor spectrum includes a first range of wavelengths and, for all wavelengths in the first range of wavelengths, a value corresponding to a wavelength; and
a controller configured to change the polishing of the outermost layer of the substrate based upon the modified value of the current spectrum.

26. A computer implemented method comprising:
irradiating a substrate undergoing polishing with light to generate reflected light;
obtaining a current spectrum of the reflected light with an in-situ optical monitoring system;
computing a value representing a function of a difference spectrum representing a difference between the current spectrum and a reference spectrum and a gain spectrum;
determining a polishing endpoint using at least one value of the function of the difference spectrum.

27. A computer implemented method comprising:
irradiating a substrate undergoing polishing with light to generate reflected light;
obtaining a current spectrum of the reflected light with an in-situ optical monitoring system;
determining a best match spectrum to the current spectrum from a plurality of reference spectra, the determining including weighting with a gain function with different values for different wavelengths;
determining a polishing endpoint using the best match spectrum.
